(19) United States
(12) Patent Application Publication
(10) Pub. No.: US 2024/0289406 A1
(43) Pub. Date: Aug. 29, 2024

(54) METHOD FOR FEATURE CONSTRUCTION, METHOD FOR CONTENT DISPLAY AND RELATED APPARATUS

(71) Applicant: Lemon Inc., Grand Cayman (KY)

(72) Inventors: Hongyu XIONG, Los Angeles, CA (US); Han WANG, Los Angeles, CA (US); Haocheng ZHANG, Los Angeles, CA (US); Bin LIU, Los Angeles, CA (US); Tai DIAO, Beijing (CN); Dan ZENG, Beijing (CN); Yiqi FENG, Los Angeles, CA (US)

(21) Appl. No.: 18/563,312

(22) PCT Filed: Apr. 28, 2022
(86) PCT No.: PCT/SG2022/050259

§ 371 Date: Nov. 21, 2023

(30) Foreign Application Priority Data
May 21, 2021 (CN) 202110560406.5

(51) Int. Cl. G06F 16/957

(52) U.S. Cl. CPC G06F 16/9574

(57) ABSTRACT

The present disclosure relates to a method for feature construction, a method for content display and a related apparatus. The method for feature construction comprises: acquiring interaction data on a content page and loading performance data of the content page; constructing a user interaction feature according to the interaction data on the content page, and constructing a page performance feature of the content page according to the loading performance data of the content page. The user interaction feature and the page performance feature are used for training a content display model, and the content display model is used for determining target content displayed to a target user.

### CROSS-REFERENCE TO RELATED APPLICATION

The present application is a National Stage of International Application No. PCT/SG2022/050259, filed on Apr. 28, 2022, which claims priority to Chinese Patent Application No. 202110560406.5, filed on May 21, 2021 and titled “METHOD FOR FEATURE CONSTRUCTION, METHOD FOR CONTENT DISPLAY AND RELATED APPARATUS”, each of which are incorporated herein by reference in its entirety.

### TECHNICAL FIELD

The present disclosure relates to computer technology, and more particularly, to a method for feature construction, a method for content display and a related apparatus.

### BACKGROUND

In the related art, analysis is usually carried out according to user information and specific content information of a content page, to determine content to be displayed to a user. For example, in a display scene of video content, analysis is usually carried out according to user information and specific content information of a video, so as to display corresponding video content to a target user. However, this scheme only considers the user information and the content information, an analysis dimension is relatively limited, and the corresponding content cannot be well displayed to the user, causing waste of content display resources.

### SUMMARY

This section is provided to introduce a concept in a brief form, and the concept will be described in detail in Description of Embodiments section below. This section is not intended to identify key features or essential features of the claimed technical solutions, nor is it intended to be used to limit the scope of the claimed technical solutions.

In a first aspect, the present disclosure provides a method for feature construction, and the method includes:
acquiring interaction data on a content page and loading performance data of the content page, the interaction data being used for representing a user behavior on the content page, the loading performance data being used for representing a loading condition of the content page, and the loading performance data including a loading duration and/or a loading success rate of the content page;
constructing a user interaction feature according to the interaction data on the content page, and constructing a page performance feature of the content page according to the loading performance data of the content page,
wherein the user interaction feature and the page performance feature are used for training a content display model, and the content display model is used for determining target content displayed to a target user.

In a second aspect, the present disclosure provides a method for content display, and the method includes:
acquiring content information of target content;
inputting the content information of the target content to a content display model to determine a target user, the content display model being obtained by training according to a user information feature of a user, a content information feature of a content page, and a user interaction feature and a page performance feature constructed according to the method of the first aspect; and displaying the target content to the target user.

In a third aspect, the present disclosure provides an apparatus for feature construction, and the apparatus includes:
a data acquisition module configured to acquire interaction data on a content page and loading performance data of the content page, the interaction data being used for representing a user behavior on the content page, the loading performance data being used for representing a loading condition of the content page, and the loading performance data including a loading duration and/or a loading success rate of the content page; and
a feature construction module configured to construct a user interaction feature according to the interaction data on the content page, and constructing a page performance feature of the content page according to the loading performance data of the content page,
wherein the user interaction feature and the page performance feature are used for training a content display model, and the content display model is used for determining target content displayed to a target user.

In a fourth aspect, the present disclosure provides an apparatus for feature construction, and the apparatus includes:
an acquisition module configured to acquire content information of target content;
a determination module configured to input the content information of the target content to a content display model to determine a target user, the content display model being obtained by training according to a user information feature of a user, a content information feature of a content page, and a user interaction feature and a page performance feature constructed according to the method of the first aspect; and a display module configured to display the target content to the target user.

In a fifth aspect, the present disclosure provides a computer readable medium. The computer readable medium has a computer program stored thereon. The program, when executed by a processing device, implements steps of the method according to the first aspect or the second aspect.

In a sixth aspect, the present disclosure provides an electronic device, including:
a storage apparatus, having a computer program stored thereon; and
a processing apparatus configured to execute the computer program in the storage device, so as to implement steps of the method according to the first aspect or the second aspect.

With the technical solutions above, the interaction data on the content page and the loading performance data of the content page can be obtained, and the features are constructed according to the interaction data and the loading performance data, so that training of the content display model can be achieved. Therefore, the content display model can be trained in combination with richer data. Not only can the result accuracy of the content display model be improved, and the waste of content display resources is reduced, but also the data utilization rate of the interaction data and the page loading performance data can be improved.

Other features and advantages of the present disclosure will be described in detail in following detailed description.

### BRIEF DESCRIPTION OF DRAWINGS

The above and other features, advantages and aspects of the embodiments of the present disclosure will become more apparent in conjunction with the accompanying drawings and with reference to following detailed description. Throughout the drawings, the same or similar reference numerals denote the same or similar elements. It should be understood that the drawings are schematic, and components and elements are not necessarily drawn to scale.

In the drawings:

FIG. 1 is a flowchart illustrating a method for feature construction according to an exemplary embodiment of the present disclosure;

FIG. 2 is a flowchart illustrating a method for content display according to an exemplary embodiment of the present disclosure;

FIG. 3 is a block diagram of an apparatus for feature construction according to an exemplary embodiment of the present disclosure;

FIG. 4 is a block diagram of an apparatus for content display according to an exemplary embodiment of the present disclosure;

FIG. 5 is a block diagram of an electronic device according to an exemplary embodiment of the present disclosure.

### DESCRIPTION OF EMBODIMENTS

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather these embodiments are provided for thorough and complete understanding of the present disclosure. It should be understood that the drawings and embodiments of the present disclosure are only used for exemplary effects, and not intended to limit the scope of protection of the present disclosure.

It should be understood that various steps described in the method embodiments of the present disclosure may be executed in different sequences, and/or executed in parallel. In addition, the method embodiments may include additional steps and/or omit the steps shown. The scope of the present disclosure is not limited in this regard.

The terms “including” and variations thereof as used herein are open ended, i.e., “including but not limited to”. The term “based on” is “at least partially based on”. The term “one embodiment” means “at least one embodiment”; the term “another embodiment” means “at least one further embodiment”; the term “some embodiments” means “at least some embodiments”. The relevant definitions of other terms are given in following description.

It should be noted that the concepts of “first”, “second” and the like mentioned in the present disclosure are only used for distinguishing different devices, modules or units, and not used for limiting the sequence or mutual dependency relationship of the functions executed by the devices, modules or units. Moreover, it should be noted that modification of “a” and “a plurality of” mentioned in the present disclosure is schematic and non-limiting, and it should be understood by a person skilled in the art that unless the context clearly indicates otherwise, it should be understood as “one or more”.

Names of message or information exchanged among multiple devices in the embodiments of the present disclosure are only used for illustrative purposes, but not intended to limit the scope of these messages or information.

It is understood that before using the technical solutions disclosed in each embodiment of the present disclosure, the user shall be informed of the type, scope of use, and use scenario of the personal information involved in the present disclosure in an appropriate manner and be authorized by the user in accordance with relevant laws and regulations.

For example, in response to an active request received from a user, a prompt message is sent to the user to clearly inform the user that the requested action will require the acquisition and use of the user's personal information. Thus, based on the prompt information, the user can independently choose whether to provide personal information to software or hardware such as electronic devices, applications, servers or storage media that perform the operation of the technical solution of the present disclosure.

As an optional but non-limited implementation method, in response to the active request of the user, the manner of sending prompt information to the user can be, for example, a popup window, in which the prompt information can be presented in the form of text. In addition, the popup can also carry a selection control for the user to choose “agree” or “disagree” to provide personal information to the electronic device.

It is understood that the above notification and acquiring user authorization process is only indicative and does not constitute a limit to the implementation of this disclosure, and other ways to meet the relevant laws and regulations can also be applied to the implementation of the present disclosure.

As described in the Background, in the related art, analysis is usually carried out according to user information and specific content information of a content page, to determine content to be displayed to a user. For example, in a display scene of video content, analysis is usually carried out according to user information and specific content information of a video, so as to display corresponding video content to a target user. However, this scheme only considers the user information and the content information, an analysis dimension is relatively limited, and the corresponding content cannot be well displayed to the user, causing waste of content display resources.

With a large amount of data analysis, the inventors found that in an advertisement content scene, the longer the stay duration of the user on an advertisement landing page is, the higher the user conversion rate will be. The conversion rate can be understood as a conversion rate from a user clicking an advertisement to becoming an effectively active user or a registered user. Specifically, when the stay duration of the user on an advertisement landing page is less than 30 seconds, an average user conversion rate is about 0.4. When the stay duration of the user on the advertisement landing page is more than 100 seconds, the average user conversion rate is about 6.8, and compared with the case where the user stays for less than 30 seconds, the average user conversion rate is increased by about 17 times.

Secondly, with a large amount of data analysis, the inventors also found that both loading time consumption of the advertisement landing page being too long or too short, and a loading success rate of the advertisement landing page being too high or too low, will influence the user conversion rate.

Specifically, when the loading time consumption of the advertisement landing page is 4-12 seconds, the average user conversion rate is about 3.4. When the loading time consumption of the advertisement landing page is less than 4 seconds or more than 12 seconds, the average user conversion rate is about 2.6, and compared with the case where the loading time consumption is 4-12 seconds, the average user conversion rate is reduced by about 30%. When the loading success rate of the advertisement landing page ranges from 45% to 80%, the average user conversion rate is 4.2. When the loading success rate of the advertisement landing page ranges from 45% to 80%, the average user conversion rate is 4.2. When the loading success rate of the advertisement landing page is smaller than 45%, the average user conversion rate is 1, and compared with the case where the loading success rate is between 45% and 80%, the average user conversion rate is reduced by about 300%. When the loading success rate of the advertisement landing page is greater than 80%, the average user conversion rate is 2.8, and compared with the case where the loading success rate is between 45% and 80%, the average user conversion rate is obviously reduced.

Therefore, the impact of display quality of a content page on the user conversion rate is relatively large, and data capable of describing the quality of the content page can be analyzed, in order to display the corresponding content to the user more accurately, thereby improving the user conversion rate. The inventors found after research that the user conversion rate can be represented by behaviors such as clicking, watching, purchasing and the like of the user.

Therefore, the present disclosure provides a method for feature construction, in order to train a content display model by constructing features based on interaction data of the user on the content page and loading performance data of the content page, namely, to train the content display model by combining with richer data, such that not only can the result accuracy of the content display model be improved and the waste of content display resources is reduced, but also a utilization rate of the interaction data and the page loading performance data can be improved, and the user conversion rate can be improved in an advertisement content scene. Firstly, it should be understood that acquisition of the interaction data in the present disclosure can be displaying an authorization prompt interface for data acquisition to the user first, for example, displaying a prompt pop-up box for querying whether the user agrees to upload his/her own interaction data, etc. After the user authorizes the data acquisition on the authorization interface, that is, after the user agrees the acquisition of his/her own interaction data on the content page, the interaction data of the user on the content page can be acquired for feature construction. That is, the interaction data in the present disclosure is acquired with the user's authorization and consent.

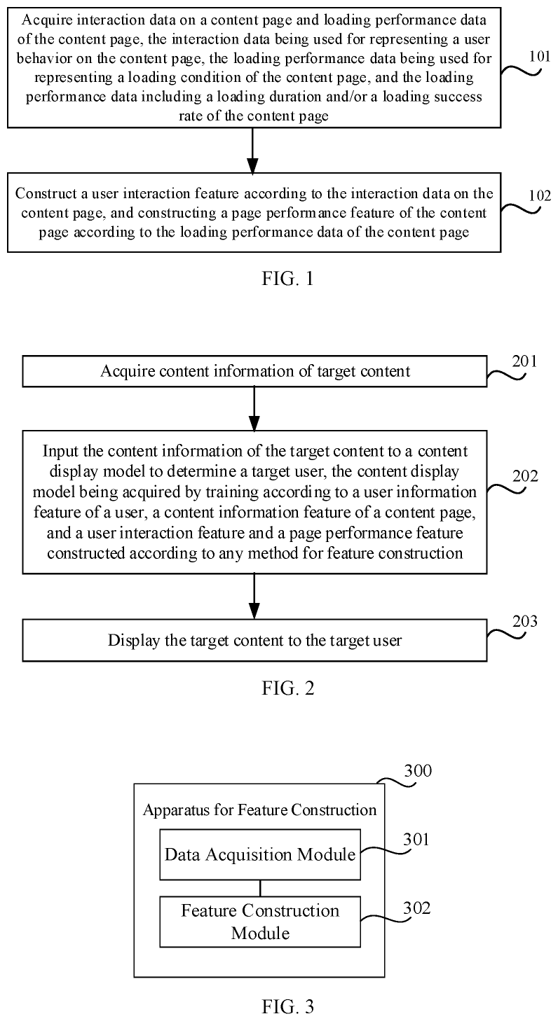

FIG. 1 is a flowchart of a method for feature construction according to an exemplary embodiment of the present disclosure. Referring to FIG. 1, the method for feature construction includes:

Step 101, acquiring interaction data on a content page and loading performance data of the content page, the interaction data being used for representing a user behavior on the content page, the loading performance data being used for representing a loading condition of the content page, and the loading performance data including a loading duration and/or a loading success rate of the content page; and

Step 102, constructing a user interaction feature according to the interaction data on the content page, and constructing a page performance feature of the content page according to the loading performance data of the content page.

The user interaction feature and the page performance feature are used for training a content display model, and the content display model is used for determining target content displayed to a target user.

For example, when the user authorizes acquisition of the interaction data of the user on the content page, the interaction data of the user on the content page can be obtained via front-end development setting. The content page may be a landing page displayed after the user clicks an advertisement, or it may be a search content page displayed to the user after the user searches, etc., which is not limited in the embodiments of the present disclosure.

The interaction data may be used to represent the user behavior of the user on the content page. For example, when the user authorizes the acquisition of the interaction data of the user on the content page, at least one of following data can be acquired as the interaction data: a stay duration of the user on the content page, interaction operation data and an exposure percentage corresponding to content seen by the user, and the exposure percentage is a ratio of a pixel area of the content page exposed to the user to a total pixel area of the content page.

In some embodiments, the operation of acquiring the loading performance data of the content page includes: acquiring, as the loading performance data of the content page, at least one of: rendering time of a first element, rendering time of a largest element of an initial screen, and an accumulated rendering offset in the content page.

In some embodiments, the operation of acquiring the loading performance data of the content page may include: acquiring, as the loading performance data of the content page, at least one of: a number of times the content page is clicked, a loading success rate and a loading duration of the content page in a predetermined duration. The predetermined duration can be set according to an actual situation, which is not limited in the embodiment of the present disclosure.

For example, the interaction operation data can be used for representing an interaction operation of the user on the content page, and it can be operation data such as clicking, scrolling and page jumping of the user on the content page, e.g., a number of clicking operations, scrolling operations, page jumping operations performed by the user on the content page. The loading performance data can include loading data such as rendering time of a first element, rendering time of a largest element of an initial screen, an accumulated rendering offset in the content page, and the like, or can further include a number of times the content page is clicked, a number of successful loadings and a loading duration of the content page in the predetermined duration.

In some embodiments, when the loading performance data of the content page comprises at least the number of times the content page is clicked, the loading success rate and the loading duration of the content page in the predetermined duration, the method may further include: determining an average number of times the content page is clicked in the predetermined duration according to the number of times the content page is clicked in the predetermined duration; determining the loading success rate of the content page in the predetermined duration according to a number of successful loadings of the content page in the predetermined duration; and determining an average loading duration of the content page in the predetermined duration according to the loading duration of the content page in the predetermined duration.

In some embodiments, the operation of constructing the page performance feature of the content page according to the loading performance data of the content page may include: according to the number of times the content page is clicked, the loading success rate, the loading duration, the average number of times the content page is clicked, the loading success rate, and the average loading duration of the content page in the predetermined duration, the page performance feature of the content page comprising at least one of: a feature of the number of times the content page is clicked in the predetermined duration; a feature of the average number of times the content page is clicked in the predetermined duration; a feature of the number of successful loadings of the content page in the predetermined duration; a feature of the loading success rate of the content page in the predetermined duration; a feature of the loading duration of the content page in the predetermined duration; and a feature of the average loading duration of the content page in the predetermined duration.

The average number of times the content page is clicked in the predetermined duration can be determined according to the number of times the content page is clicked in the predetermined duration. The loading success rate of the content page in the predetermined duration can be determined according to the number of successful loadings of the content page in the predetermined duration. The average loading duration of the content page in the predetermined duration can be determined according to the loading duration of the content page in the predetermined duration. Therefore, the feature construction can be performed according to the loading performance data of the content page in the predetermined duration to obtain following page performance features: a feature of the number of times the content page is clicked in the predetermined duration; a feature of the number of successful loadings of the content page in the predetermined duration; a feature of the loading success rate of the content page in the predetermined duration; a feature of the loading duration of the content page in the predetermined duration; and a feature of the average loading duration of the content page in the predetermined duration.

In some embodiments, the operation of acquiring the interaction data on the content page may include: acquiring interaction data on each of a plurality of the content pages; and determining average interaction data corresponding to the plurality of the content pages according to the interaction data on each of the content pages. Accordingly, the operation of constructing the user interaction feature according to the interaction data on the content page may include: constructing a single interaction feature corresponding to each of the content pages according to the interaction data on each of the content pages, and constructing an average interaction feature corresponding to the plurality of the content pages according to the average interaction data corresponding to the plurality of the content pages.

Exemplarily, the average interaction data can be obtained by performing average calculation according to the interaction data corresponding to each of the plurality of the content pages, for example, with the user's authorization and consent, it can include average data such as an average stay duration, an average number of clicking operations, an average number of scrolling operations, an average number of jumping operations, and the like, performed by the user on the plurality of the content pages.

For example, with the user's authorization, interaction data such as the stay duration, the number of clicking operations, the number of scrolling operations, the number of jumping operations, the page exposure percentage, and the like, performed by the user on the plurality of the content pages can be acquired. For each content page, a single interaction feature between the user and the content page can be constructed according to the interaction data of the user on the content page. Further, an average interaction feature of the user and the plurality of the content pages can be constructed according to the average interaction data of the user on the plurality of the content pages, and finally user interaction features shown in Table 1 can be acquired:

TABLE 1

| | | Meaning of |
|---|---|---|
| | Name of Feature | Feature |
| Single | u_stay_time_pixel_list | Stay Duration |
| Interaction | u_num_click_pixel_list | Number of |
| Feature | | Clicking |
| | | Operations |
| | u_num_page_scroll_pixel_list | Number of |
| | | Scrolling |
| | | Operations |
| | u_num_jump_page_pixel_list | Number of |
| | | Jumping |
| | | Operations |
| | u_page_exposure_pixel_list | Exposure |
| | | Percentage |
| Average | u_stay_time_pixel_avg_metric | Average Stay |
| Interaction | | Duration |
| Feature | u_num_click_pixel_avg_metric | Average Number |
| | | of Clicking |
| | | Operations |
| | u_num_page_scroll_pixel_avg_metric | Average Number |
| | | of Scrolling |
| | | Operations |
| | u_num_jump_page_pixel_avg_metric | Average Number |
| | | of Jumping |
| | | Operations |
| | u_page_exposure_pixel_avg_metric | Average |
| | | Exposure |
| | | Percentage |

In this way, the user interaction features can be constructed according to the interaction data of each content page and the average interaction data of the plurality of the content pages, such that feature construction can be carried out according to richer data, thereby improving the result accuracy of the content display model trained according to the features, reducing the waste of content display resources, and further improving the utilization rate of the interaction data.

In some embodiments, the operation of constructing the user interaction feature according to the interaction data on the content page may include: sorting the interaction data on the content page according to a corresponding data index, and selecting target interaction data from the sorted interaction data; and constructing the user interaction feature according to the target interaction data.

Exemplarily, the data index corresponding to the interaction data may be used for representing a numerical unit of the interaction data. For example, the interaction data is the number of clicking operations, then sorting the interaction data according to the corresponding data index can be sorting the interaction data according to the number of clicking operations. Alternatively, the interaction data is the stay duration, then sorting the interaction data according to the corresponding data index can be sorting according to the stay duration.

After the interaction data is sorted, the target interaction data can be selected from the sorted interaction data. For example, the interaction data is the number of clicking operations, and after the numbers of clicking operations are sorted in a descending order, the first ten pieces of interaction data are selected as the target interaction data.

In this way, the acquired interaction data can be sorted and truncated, to remove interference of some accidental data, so that the constructed user interaction features better conform to an actual interaction behavior of the user, thereby improving the result accuracy of the content display model trained according to the user interaction features, and reducing the waste of content display resources.

In addition to acquiring the user interaction data with the user authorization, the present disclosure can also acquire the loading performance data of the content page, so that feature construction can be carried out based on richer data.

In some embodiments, the operation of acquiring the loading performance data of the content page may include: acquiring the loading performance data of the content page in different time dimensions. Accordingly, the operation of constructing the page performance feature of the content page according to the loading performance data of the content page may include: constructing the page performance feature of the content page according to the loading performance data of the content page in different time dimensions.

In some embodiments, the operation of acquiring the loading performance data of the content page of different time dimensions may include: acquiring first loading performance data of the content page in a first predetermined duration and second loading performance data of the content page in a second predetermined duration. Time represented by the second predetermined duration is longer than time represented by the first predetermined duration. Accordingly, the operation of constructing the page performance feature of the content page according to the loading performance data of the content page in different time dimensions may include: constructing the page performance feature of the content page according to the first loading performance data and the second loading performance data.

For example, the first predetermined duration and the second predetermined duration can be set according to actual conditions, which is not limited in the embodiment of the present disclosure, so long as the time represented by the second predetermined duration is longer than the time represented by the first predetermined duration. When the present disclosure is specifically implemented, the loading performance data of the content page in the first predetermined duration and in the second predetermined duration can be acquired respectively, or the loading performance data of the content page in the second predetermined duration can be acquired first, as the time represented by the second predetermined duration is longer than the time represented by the first predetermined duration, and then the loading performance data in the first predetermined duration is selected from the loading performance data in the second predetermined duration, which is not limited in the disclosure.

For example, the first predetermined duration is the latest day, the second predetermined duration is the latest week, the loading performance data of the latest week can be acquired first, and then loading performance data of the latest day can be selected from the loading performance data of the latest week according to time identification information. Then, feature construction is carried out according to the first loading performance data of the content page in the first predetermined duration and the second loading performance data of the content page in the second predetermined duration, so that the page performance feature shown in Table 2 can be acquired:

TABLE 2

| | Name of Feature | Meaning of Feature |
|---|---|---|
| Page Performance | f_pixel_page_click_1d | Number of Clicking |
| Feature in First | | Operations in Latest |
| Predetermined | | Day |
| Duration | f_pixel_page_load_finish_1d | Number of Successful |
| | | Loadings in Latest Day |
| | f_pixel_page_load_rate_1d | Loading Success Rate |
| | | in Latest Day |
| | f_pixel_page_load_duration_sum_1d | Loading Duration in |
| | | Latest Day |
| | f_pixel_page_load_avg_duration_1d | Average Loading Duration |
| | | in Latest Day |
| Page Performance | f_pixel_page_click_7d | Number of Clicking |
| Feature in Second | | Operations in Latest |
| Predetermined | | Week |
| Duration | f_pixel_page_load_finish_7d | Number of Successful |
| | | Loadings in Latest Week |
| | f_pixel_page_load_rate_7d | Loading Success Rate |
| | | in Latest Week |
| | f_pixel_page_load_duration_sum_7d | Loading Duration in |
| | | Latest Week |
| | f_pixel_page_load_avg_duration_7d | Average Loading |
| | | Duration in Latest Week |

In this way, the loading performance data in different time dimensions can be acquired, so that the feature construction can be carried out according to the loading performance data in different time dimensions, to obtain richer page performance features, thereby improving the result accuracy of the content display model trained according to the page performance feature, reducing the waste of content display resources, and increasing the utilization rate of the loading performance data. In addition, the page performance feature with better timeliness can be acquired based on the loading performance data of the first predetermined duration, and the page performance feature capable of reflecting a page loading time change condition can be acquired based on the loading performance data of the second predetermined duration, so that the feature construction can be carried out according to the loading performance data of different time dimensions, and feature construction requirements in different scenes can be met.

Based on the same inventive concept, the present disclosure further provides a method for content display. Referring to FIG. 2, the method includes:

Step 201, acquiring content information of target content;

Step 202, inputting the content information of the target content to a content display model to determine a target user, the content display model being acquired by training according to a user information feature of a user, a content information feature of a content page, and a user interaction feature and a page performance feature constructed according to any method for feature construction described above; and

Step 203, displaying the target content to the target user.

Exemplarily, the content information is used for representing basic content such as characters and pictures of the content page, and the content information feature of the content page can be obtained by performing feature extraction from the content information. The user information is used for representing personal information of the user, and the user information can be acquired with the user's authorization, so that the user information feature can be obtained by performing feature extraction from the user information. For the above manner of acquiring and using user information, please refer to the descriptions in paragraphs 0038-0041 of the present disclosure.

It should be understood that in the related art, after a parameter of the content display model is initialized, a content information feature of historical content is usually inputted into the content display model for estimation, to obtain an estimated user, and then the estimated user is compared with a user who actually browses the historical content, to calculate a loss function. Back propagation is then performed according to a calculation result of the loss function, to update the parameter of the model. Moreover, a process of inputting the content information feature of the historical content to the content display model for estimation to obtain the estimated user, then comparing the estimated user with the user who actually browses the historical content to calculate the loss function, and then carrying out the back propagation according to the calculation result of the loss function so as to update the parameter of the model will be repeatedly executed until the loss function is no longer remarkably reduced. Then, in a model application stage, the content information of the target content can be inputted to the model to obtain an estimated target user, so that the target content is pushed to the target user.

However, it has been described above that this scheme only considers the user information and the content information, and the analysis dimension is relatively limited, so that the estimation accuracy of the content display model will be influenced, and the corresponding content cannot be well displayed to the target user, further causing the waste of content display resources.

Therefore, the present disclosure provides a new content display mode, which can train the content display model in combination with the user information feature, the content information feature, and the user interaction feature and the page performance feature constructed according to any method for feature construction described above, so as to train the model based on richer data, to improve the accuracy of the model. The related content of the user interaction feature and the page performance feature has been described above, and details are not described herein again. Specifically, after testing, compared with a content display model trained based only on the user information feature and the content information feature, an Area Under the Curve (AUC) of the content display model in the embodiment of the present disclosure can be improved by 0.2%, and an audience user of an advertisement can be determined more accurately in the advertisement content scene, so that the user conversion rate is improved.

Based on the same inventive concept, the present disclosure further provides an apparatus for feature construction, and the apparatus can be part or all of an electronic device in the form of software, hardware or a combination thereof. Referring to FIG. 3, the apparatus for feature construction 300 includes:
a data acquisition module 301 configured to acquire interaction data on a content page and loading performance data of the content page, the interaction data being used for representing a user behavior on the content page, the loading performance data being used for representing a loading condition of the content page, and the loading performance data including a loading duration and/or a loading success rate of the content page; and
a feature construction module 302 configured to construct a user interaction feature according to the interaction data on the content page, and constructing a page performance feature of the content page according to the loading performance data of the content page.

The user interaction feature and the page performance feature are used for training a content display model, and the content display model is used for determining target content displayed to a target user.

In some embodiments, the data acquisition module 301 may be configured to:
acquire, as the loading performance data of the content page, at least one of: a number of times the content page is clicked, a loading success rate and a loading duration of the content page in a predetermined duration.

In some embodiments, the data acquisition module 301 may be configured to:
acquire interaction data on each of a plurality of the content pages; and
determine average interaction data corresponding to the plurality of the content pages according to the interaction data on each of the content pages, and
the feature construction module 302 may be configured to:
construct a single interaction feature corresponding to each of the content pages according to the interaction data on each of the content pages, and construct an average interaction feature corresponding to the plurality of the content pages according to the average interaction data corresponding to the plurality of the content pages.

In some embodiments, the feature construction module 302 may be configured to:
sort the interaction data on the content page according to a corresponding data index, and select target interaction data from the sorted interaction data; and
construct the user interaction feature according to the target interaction data.

In some embodiments, the data acquisition module 301 may be configured to: acquire the loading performance data of the content page in different time dimensions; and
the feature construction module 302 may be configured to: construct the page performance feature of the content page according to the loading performance data of the content page in different time dimensions.

In some embodiments, the data acquisition module 301 may be configured to:
acquire first loading performance data of the content page in a first predetermined duration and second loading performance data of the content page in a second predetermined duration, wherein time represented by the second predetermined duration is longer than time represented by the first predetermined duration;
the feature construction module 302 may be configured to:
construct the page performance feature of the content page according to the first loading performance data and the second loading performance data.

In some embodiments, when the loading performance data of the content page comprises at least the number of times the content page is clicked, the loading success rate and the loading duration of the content page in the predetermined duration, the feature construction module 302 may be further configured to: determine an average number of times the content page is clicked in the predetermined duration according to the number of times the content page is clicked in the predetermined duration; determine the loading success rate of the content page in the predetermined duration according to a number of successful loadings of the content page in the predetermined duration; and determine an average loading duration of the content page in the predetermined duration according to the loading duration of the content page in the predetermined duration.

In some embodiments, the feature construction module 302 may be configured to: accord to the number of times the content page is clicked, the loading success rate, the loading duration, the average number of times the content page is clicked, the loading success rate, and the average loading duration of the content page in the predetermined duration, the page performance feature of the content page including at least one of: a feature of the number of times the content page is clicked in the predetermined duration; a feature of the average number of times the content page is clicked in the predetermined duration; a feature of the number of successful loadings of the content page in the predetermined duration; a feature of the loading success rate of the content page in the predetermined duration; a feature of the loading duration of the content page in the predetermined duration; and a feature of the average loading duration of the content page in the predetermined duration.

In some embodiments, the data acquisition module 301 may be configured to: acquire, as the loading performance data of the content page, at least one of: rendering time of a first element, rendering time of a largest element of an initial screen, and an accumulated rendering offset in the content page.

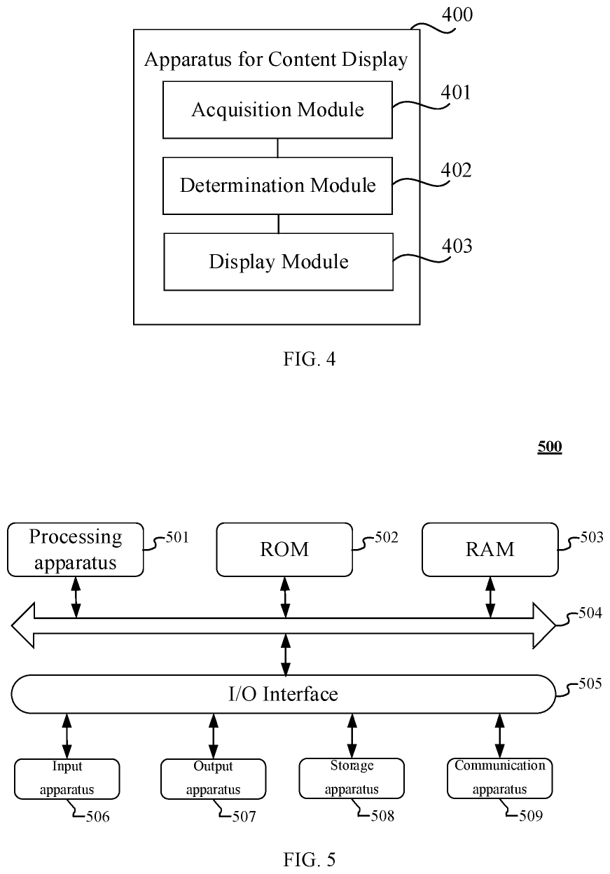

Based on the same inventive concept, the present disclosure further provides an apparatus for content display, and the apparatus can be part or all of an electronic device in the form of software, hardware or a combination thereof. Referring to FIG. 4, the apparatus for content display 400 includes:
an acquisition module 401 configured to acquire content information of target content;
a determination module 402 configured to input the content information of the target content to a content display model to determine a target user, the content display model being obtained by training according to a user information feature of a user, a content information feature of a content page, and a user interaction feature and a page performance feature constructed according to any method for feature construction described above;
a display module 403 configured to display the target content to the target user.

It should be understood that in some embodiments, the electronic device may include an apparatus for feature construction as shown in FIG. 3 and an apparatus for content display as shown in FIG. 4. A user interaction feature and a page performance feature can be constructed by the apparatus for feature construction, for training a content display model in the apparatus for content display.

Based on the same inventive concept, the present disclosure further provides a computer readable medium, having a computer program stored thereon. When the program is executed by a processing device, it implements steps of any method for feature construction or any method for content display described above.

Based on the same inventive concept, the present disclosure further provides an electronic device, including:
a storage device, having a computer program stored thereon; and
a processing apparatus configured to execute the computer program in the storage device, so as to implement steps of any method for feature construction or any method for content display described above.

Referring to FIG. 5, a structural schematic diagram of an electronic device 500 suitable for implementing the embodiments of the present disclosure is shown. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), a vehicle-mounted terminal (such as a vehicle-mounted navigation terminal), and the like, and a fixed terminal such as a digital TV and a desktop computer.

The electronic device shown in FIG. 5 is merely an example, which should not bring any limitation to the functions and use ranges of the embodiments of the present disclosure.

As shown in FIG. 5, the electronic device 500 may include a processing apparatus (e.g., a central processor, a graphics processor, etc.) 501, which may perform various appropriate actions and processes according to a program stored in a read-only memory (ROM) 502 or a program loaded into a random-access memory (RAM) 503 from a storage apparatus 508. In the RAM 503, various programs and data required for an operation of the electronic device 500 are also stored. The processing apparatus 501, the ROM 502, and the RAM 503 are connected to each other by a bus 504. An input/output (I/O) interface 505 is also connected to the bus 504.

Generally, following apparatuses may be connected to the I/O interface 505: an input apparatus 506 including, for example, a touch screen, a touchpad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, tape, hard disk, etc.; and a communication apparatus 509. The communication apparatus 509 may allow the electronic device 500 to perform wireless or wired communication with other apparatus to exchange data. Although FIG. 5 shows the electronic device 500 having various apparatuses, it is to be understood that it is not required to implement or have all of the illustrated apparatuses. More or fewer apparatuses may alternatively be implemented or provided.

In particular, according to embodiments of the present disclosure, the process described above with reference to the flowchart may be implemented as a computer software program. For example, the embodiment of the present disclosure includes a computer program product that includes a computer program carried on a non-transitory computer-readable medium, and the computer program includes a program code for executing the method shown in the flowchart. In such embodiments, the computer program may be downloaded and installed from a network via the communication apparatus 509, or installed from the storage apparatus 508, or installed from the ROM 502. When the computer program is executed by the processing apparatus 501, the function defined in the method of the embodiment of the present disclosure is executed.

It should be noted that the computer readable medium of the present disclosure may be a computer readable signal medium or a computer readable storage medium, or any combination of the two. The computer readable storage medium may be, for example, but not limited to, an electrical, magnetic, optical, electromagnetic, infrared, or semiconductor system, device, or component, or any combination thereof. More specific examples of computer-readable storage media may include, but are not limited to, electrically connected by one or more wires, portable computer disk, hard disk, random access memory (RAM), read-only memory (ROM), erasable programmable read-only memory (EPROM or flash memory), optical fiber, portable compact disk read-only memory (CD-ROM), optical storage component, magnetic storage component, or any suitable combination thereof. In the present disclosure, the computer-readable storage medium may be any tangible medium that includes or stores a program, and the program can be used by or in connection with an instruction execution system, device, or component. While in the present disclosure, the computer-readable signal medium may include a data signal propagated in a baseband or as part of a carrier, and the computer-readable program code is carried therein. Such propagated data signals may take a variety of forms, including, but not limited to, electromagnetic signals, optical signals, or any suitable combination thereof. The computer-readable signal medium may also be any computer-readable medium other than the computer-readable storage medium, and the computer-readable signal medium may send, propagate, or transmit a program used by or in connection with an instruction execution system, device, or component. The program code contained on the computer-readable medium can be transmitted by any suitable medium, including but not limited to, electric wires, optical cables, RF (radio frequency) and the like, or any suitable combination of the above.

In some embodiments, communication may be achieved by using any currently known or future developed network protocol, such as HTTP (Hypertext Transfer Protocol), and may be interconnected with any form or medium of digital data communication (e.g., communication network). Examples of the communication network include local area networks (“LAN”), wide area networks (“WAN”), Internet networks (e.g., the Internet), and end-to-end networks (e.g., Ad hoc end-to-end networks), as well as any currently known or future developed networks.

The computer readable medium mentioned above can be contained in the electronic device; and it can also exist alone and is not assembled into the electronic device.

The computer readable medium carries one or more programs, and when the one or more programs are executed by the electronic device, the electronic device is caused to: acquire interaction data on a content page and loading performance data of the content page, the interaction data being used for representing a user behavior on the content page, the loading performance data is used for representing a loading condition of the content page, and the loading performance data including a loading duration and/or a loading success rate of the content page; construct a user interaction feature according to the interaction data on the content page, and construct a page performance feature of the content page according to the loading performance data of the content page. The user interaction feature and the page performance feature are used for training a content display model, and the content display model is used for determining target content displayed to a target user.

A computer program code for executing an operation of the present disclosure may be written in one or more programming languages, and the programming languages include, but not limited to, object-oriented programming languages, such as Java, Smalltalk, C++, and conventional procedural programming languages, such as “C” languages or similar programming languages. The program code may be executed entirely on the user's computer, executed partly on the user's computer, executed as a stand-alone software package, executed partly on the user's computer and partly on a remote computer, or executed entirely on the remote computer or server. In the case of the remote computer, the remote computer may be connected to the user computer through any type of network, including a local area network (LAN) or a wide area network (WAN), or it may be connected to an external computer (e.g., via the Internet using an Internet Service Provider)).

The flowcharts and block diagrams in the company drawings illustrate the architecture, functionality, and operation of possible implementations of systems, methods, and computer program products in accordance with various embodiments of the present disclosure. In this regard, each block in the flowcharts or block diagrams may represent a module, a program segment, or a portion of the code, and the module, the program segment, or the portion of the code include one or more executable instructions for implementing a specified logical function. It should also be noted that, in some alternative implementations, functions noted in the block may occur out of the order noted in the drawings. For example, two blocks represented in succession may, in fact, be executed substantially in parallel, and they may sometimes be executed in a reverse order, depending upon functions involved. It is also noted that each block of the block diagrams and/or flowcharts, and combinations of blocks in the block diagrams and/or flowcharts, may be implemented with an application-specific hardware-based system that executes specified functions or operations, or may be implemented with a combination of application-specific hardware and computer instructions.

The modules involved in the embodiments of the present disclosure may be implemented by means of software or may be implemented by means of hardware. A name of the module does not constitute a limitation on the module itself in some cases.

The functions described herein may be executed at least in part by one or more hardware logic components. For example, non-limiting, exemplary types of the hardware logic components that may be used include: a field programmable gate array (FPGA), an application specific integrated circuit (ASIC), an application specific standard par (ASSP), an on-chip system (SOC), a complex programmable logic device (CPLD), and the like.

In the context of the present disclosure, a machine-readable medium may be a tangible medium that may contain or store a program used by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor system, device, or apparatus, or any suitable combination of the foregoing. More specific examples of a machine-readable storage medium may include electrically connected by one or more wires, portable computer disk, hard disk, random access memory (RAM), read-only memory (ROM), erasable programmable read-only memory (EPROM or flash memory), optical fiber, portable compact disk read-only memory (CD-ROM), optical storage component, magnetic storage component, or any suitable combination thereof.

According to one or more embodiments of the present disclosure, Example 1 provides a method for feature construction, and the method includes: acquiring interaction data on a content page and loading performance data of the content page, the interaction data being used for representing a user behavior on the content page, the loading performance data being used for representing a loading condition of the content page, and the loading performance data including a loading duration and/or a loading success rate of the content page; constructing a user interaction feature according to the interaction data on the content page, and constructing a page performance feature of the content page according to the loading performance data of the content page. The user interaction feature and the page performance feature are used for training a content display model, and the content display model is used for determining target content displayed to a target user.

According to one or more embodiments of the present disclosure, Example 2 provides the method of Example 1, and the operation of acquiring the loading performance data of the content page includes: acquiring, as the loading performance data of the content page, at least one of: a number of times the content page is clicked, a loading success rate and a loading duration of the content page in a predetermined duration.

According to one or more embodiments of the present disclosure, Example 3 provides the method of Example 1 or 2, and the operation of acquiring the interaction data on the content page includes: acquiring interaction data on each of a plurality of the content pages; and determining average interaction data corresponding to the plurality of the content pages according to the interaction data on each of the content pages, and
the operation of constructing the user interaction feature according to the interaction data on the content page includes: constructing a single interaction feature corresponding to each of the content pages according to the interaction data on each of the content pages, and constructing an average interaction feature corresponding to the plurality of the content pages according to the average interaction data corresponding to the plurality of the content pages.

According to one or more embodiments of the present disclosure, Example 4 provides the method of Example 1 or 2, and the operation of constructing the user interaction feature according to the interaction data on the content page includes: sorting the interaction data on the content page according to a corresponding data index, and selecting target interaction data from the sorted interaction data; and constructing the user interaction feature according to the target interaction data.

According to one or more embodiments of the present disclosure, Example 5 provides the method of Example 1 or 2, and the operation of acquiring the loading performance data of the content page includes: acquiring the loading performance data of the content page in different time dimensions; and
the operation of constructing the page performance feature of the content page according to the loading performance data of the content page includes: constructing the page performance feature of the content page according to the loading performance data of the content page in different time dimensions.

According to one or more embodiments of the present disclosure, Example 6 provides the method of Example 5, and the operation of acquiring the loading performance data of the content page of different time dimensions includes: acquiring first loading performance data of the content page in a first predetermined duration and second loading performance data of the content page in a second predetermined duration, wherein time represented by the second predetermined duration is longer than time represented by the first predetermined duration; and
the operation of constructing the page performance feature of the content page according to the loading performance data of the content page in different time dimensions includes: constructing the page performance feature of the content page according to the first loading performance data and the second loading performance data.

According to one or more embodiments of the present disclosure, Example 7 provides the method of Example 2, and when the loading performance data of the content page comprises at least the number of times the content page is clicked, the loading success rate and the loading duration of the content page in the predetermined duration, the method further includes: determining an average number of times the content page is clicked in the predetermined duration according to the number of times the content page is clicked in the predetermined duration; determining the loading success rate of the content page in the predetermined duration according to a number of successful loadings of the content page in the predetermined duration; and determining an average loading duration of the content page in the predetermined duration according to the loading duration of the content page in the predetermined duration.

According to one or more embodiments of the present disclosure, Example 8 provides the method of Example 7, and the operation of constructing the page performance feature of the content page according to the loading performance data of the content page includes: according to the number of times the content page is clicked, the loading success rate, the loading duration, the average number of times the content page is clicked, the loading success rate, and the average loading duration of the content page in the predetermined duration, the page performance feature of the content page comprising at least one of: a feature of the number of times the content page is clicked in the predetermined duration; a feature of the average number of times the content page is clicked in the predetermined duration; a feature of the number of successful loadings of the content page in the predetermined duration; a feature of the loading success rate of the content page in the predetermined duration; a feature of the loading duration of the content page in the predetermined duration; and a feature of the average loading duration of the content page in the predetermined duration.

According to one or more embodiments of the present disclosure, Example 9 provides the method of Example 2, and the operation of acquiring the loading performance data of the content page includes: acquiring, as the loading performance data of the content page, at least one of: rendering time of a first element, rendering time of a largest element of an initial screen, and an accumulated rendering offset in the content page.

According to one or more embodiments of the present disclosure, Example 10 provides a method for content display, and the method includes:
acquiring content information of target content;
inputting the content information of the target content to a content display model to determine a target user, the content display model being obtained by training according to a user information feature of a user, a content information feature of a content page, and a user interaction feature and a page performance feature constructed according to the method of Example 1; and
displaying the target content to the target user.

According to one or more embodiments of the present disclosure, Example 11 provides an apparatus for feature construction, and the apparatus includes:
a data acquisition module configured to acquire interaction data on a content page and loading performance data of the content page, the interaction data being used for representing a user behavior on the content page, the loading performance data being used for representing a loading condition of the content page, and the loading performance data including a loading duration and/or a loading success rate of the content page; and
a feature construction module configured to construct a user interaction feature according to the interaction data on the content page, and constructing a page performance feature of the content page according to the loading performance data of the content page.

The user interaction feature and the page performance feature are used for training a content display model, and the content display model is used for determining target content displayed to a target user.

According to one or more embodiments of the present disclosure, Example 12 provides the apparatus of Example 11, and the data acquisition module is configured to: acquire, as the loading performance data of the content page, at least one of: a number of times the content page is clicked, a loading success rate and a loading duration of the content page in a predetermined duration.

According to one or more embodiments of the present disclosure, Example 13 provides the apparatus of Example 11 or 12, and the data acquisition module is configured to: acquiring interaction data on each of a plurality of the content pages; and determining average interaction data corresponding to the plurality of the content pages according to the interaction data on each of the content pages, and
the feature construction module is configured to: construct a single interaction feature corresponding to each of the content pages according to the interaction data on each of the content pages, and constructing an average interaction feature corresponding to the plurality of the content pages according to the average interaction data corresponding to the plurality of the content pages.

According to one or more embodiments of the present disclosure, Example 14 provides the apparatus of Example 11 or 12, and the feature construction module is configured to: sort the interaction data on the content page according to a corresponding data index, and select target interaction data from the sorted interaction data; and construct the user interaction feature according to the target interaction data.

According to one or more embodiments of the present disclosure, Example 15 provides the apparatus of Example 11 or 12, and the data acquisition module is configured to: acquire the loading performance data of the content page in different time dimensions; and
the feature construction module is configured to: construct the page performance feature of the content page according to the loading performance data of the content page in different time dimensions.

According to one or more embodiments of the present disclosure, Example 16 provides the apparatus of Example 15, and the data acquisition module is configured to: acquire first loading performance data of the content page in a first predetermined duration and second loading performance data of the content page in a second predetermined duration, wherein time represented by the second predetermined duration is longer than time represented by the first predetermined duration; and
the feature construction module is configured to: construct the page performance feature of the content page according to the first loading performance data and the second loading performance data.

According to one or more embodiments of the present disclosure, Example 17 provides the apparatus of Example 12, and when the loading performance data of the content page comprises at least the number of times the content page is clicked, the loading success rate and the loading duration of the content page in the predetermined duration, the feature construction module is further configured to: determine an average number of times the content page is clicked in the predetermined duration according to the number of times the content page is clicked in the predetermined duration; determine the loading success rate of the content page in the predetermined duration according to a number of successful loadings of the content page in the predetermined duration; and determine an average loading duration of the content page in the predetermined duration according to the loading duration of the content page in the predetermined duration.

According to one or more embodiments of the present disclosure, Example 18 provides the apparatus of Example 12, and the feature construction module is configured to:
accord to the number of times the content page is clicked, the loading success rate, the loading duration, the average number of times the content page is clicked, the loading success rate, and the average loading duration of the content page in the predetermined duration, the page performance feature of the content page including at least one of: a feature of the number of times the content page is clicked in the predetermined duration; a feature of the average number of times the content page is clicked in the predetermined duration; a feature of the number of successful loadings of the content page in the predetermined duration; a feature of the loading success rate of the content page in the predetermined duration; a feature of the loading duration of the content page in the predetermined duration; and a feature of the average loading duration of the content page in the predetermined duration.

According to one or more embodiments of the present disclosure, Example 19 provides the apparatus of Example 12, and the data acquisition module is configured to: acquire, as the loading performance data of the content page, at least one of: rendering time of a first element, rendering time of a largest element of an initial screen, and an accumulated rendering offset in the content page.

According to one or more embodiments of the present disclosure, Example 20 provides an apparatus for content display, and the apparatus includes:
an acquisition module configured to acquire content information of target content;
a determination module configured to input the content information of the target content to a content display model to determine a target user, the content display model being obtained by training according to a user information feature of a user, a content information feature of a content page, and a user interaction feature and a page performance feature constructed according to the method of Example 1; and
a display module configured to display the target content to the target user.

According to one or more embodiments of the present disclosure, Example 21 provides a computer readable medium, having a computer program stored thereon, wherein the program, when executed by a processing device, implements steps of the method according to any one of Examples 1-10.

According to one or more embodiments of the present disclosure, Example 21 provides an electronic device, including:
a storage apparatus, having a computer program stored thereon; and
a processing apparatus configured to execute the computer program in the storage device, so as to implement steps of the method according to any one of Examples 1-10.

The above description is merely a description of the preferred embodiments of the present disclosure and the technical principles used. It should be understood by those skilled in the art that the scope of disclosure involved in the present disclosure is not limited to the technical solution formed by a specific combination of the above-mentioned technical features, and it also covers other technical solutions formed by any combination of the above-mentioned technical features or equivalent features thereof without departing from the disclosed concept. For example, the above-mentioned features and the technical features disclosed in the present disclosure (but not limited to) having similar functions are replaced with each other.

Further, while various operations are depicted in a particular order, it should not be understood that these operations are required to be executed in the particular order shown or in sequential order. Multitasking and parallel processing may be advantageous in a certain environment. Likewise, although several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in various embodiments separately or in any suitable sub-combination.

Although the subject matter has been described in language specific to structural features and/or methodological acts, it should be understood that the subject matter defined in the appended claims is not necessarily limited to the particular features or acts described above. Rather, the specific features and acts described above are merely exemplary forms of implementing the claims. With regard to the device in the above embodiments, the specific manner in which each module performs an operation has been described in detail in embodiments related to the method, which will not be described in detail herein.

1-14. (canceled)

15. A method for feature construction, comprising:
acquiring interaction data on a content page and loading performance data of the content page, the interaction data being used for representing a user behavior on the content page, the loading performance data being used for representing a loading condition of the content page, and the loading performance data including a loading duration and/or a loading success rate of the content page;
constructing a user interaction feature according to the interaction data on the content page, and constructing a page performance feature of the content page according to the loading performance data of the content page,
wherein the user interaction feature and the page performance feature are used for training a content display model, and the content display model is used for determining target content displayed to a target user.

16. The method according to claim 15, wherein said acquiring the loading performance data of the content page comprises:
acquiring, as the loading performance data of the content page, at least one of: a number of times the content page is clicked, a loading success rate and a loading duration of the content page in a predetermined duration.

17. The method according to claim 15, wherein said acquiring the interaction data on the content page comprises:
acquiring interaction data on each of a plurality of the content pages; and
determining average interaction data corresponding to the plurality of the content pages according to the interaction data on each of the content pages, and
said constructing the user interaction feature according to the interaction data on the content page comprises:
constructing a single interaction feature corresponding to each of the content pages according to the interaction data on each of the content pages, and constructing an average interaction feature corresponding to the plurality of the content pages according to the average interaction data corresponding to the plurality of the content pages.

18. The method according to claim 15, wherein said constructing the user interaction feature according to the interaction data on the content page comprises:
sorting the interaction data on the content page according to a corresponding data index, and selecting target interaction data from the sorted interaction data; and
constructing the user interaction feature according to the target interaction data.

19. The method according to claim 15, wherein said acquiring the loading performance data of the content page comprises:
acquiring the loading performance data of the content page in different time dimensions; and
said constructing the page performance feature of the content page according to the loading performance data of the content page comprises:
constructing the page performance feature of the content page according to the loading performance data of the content page in different time dimensions.

20. The method according to claim 19, wherein said acquiring the loading performance data of the content page of different time dimensions comprises:
acquiring first loading performance data of the content page in a first predetermined duration and second loading performance data of the content page in a second predetermined duration, wherein time represented by the second predetermined duration is longer than time represented by the first predetermined duration; and
said constructing the page performance feature of the content page according to the loading performance data of the content page in different time dimensions comprises:
constructing the page performance feature of the content page according to the first loading performance data and the second loading performance data.

21. The method according to claim 16, wherein, when the loading performance data of the content page comprises at least the number of times the content page is clicked, the loading success rate and the loading duration of the content page in the predetermined duration, the method further comprises:
determining an average number of times the content page is clicked in the predetermined duration according to the number of times the content page is clicked in the predetermined duration;
determining the loading success rate of the content page in the predetermined duration according to a number of successful loadings of the content page in the predetermined duration; and
determining an average loading duration of the content page in the predetermined duration according to the loading duration of the content page in the predetermined duration.

22. The method according to claim 21, wherein said constructing the page performance feature of the content page according to the loading performance data of the content page comprises:
according to the number of times the content page is clicked, the loading success rate, the loading duration, the average number of times the content page is clicked, the loading success rate, and the average loading duration of the content page in the predetermined duration, the page performance feature of the content page comprising at least one of:
a feature of the number of times the content page is clicked in the predetermined duration;
a feature of the average number of times the content page is clicked in the predetermined duration;
a feature of the number of successful loadings of the content page in the predetermined duration;
a feature of the loading success rate of the content page in the predetermined duration;
a feature of the loading duration of the content page in the predetermined duration; and
a feature of the average loading duration of the content page in the predetermined duration.

23. The method according to claim 16, wherein said acquiring the loading performance data of the content page comprises:
acquiring, as the loading performance data of the content page, at least one of: rendering time of a first element, rendering time of a largest element of an initial screen, and an accumulated rendering offset in the content page.

24. A method for content display, comprising:
acquiring content information of target content;
inputting the content information of the target content to a content display model to determine a target user, the content display model being obtained by training according to a user information feature of a user, a content information feature of a content page, and a user interaction feature and a page performance feature constructed according to claim 15; and
displaying the target content to the target user.

25. A computer readable medium, having a computer program stored thereon, wherein the program, when executed by a processing device, causes the processing device to:
acquire interaction data on a content page and loading performance data of the content page, the interaction data being used for representing a user behavior on the content page, the loading performance data being used for representing a loading condition of the content page, and the loading performance data including a loading duration and/or a loading success rate of the content page;
construct a user interaction feature according to the interaction data on the content page, and construct a page performance feature of the content page according to the loading performance data of the content page,
wherein the user interaction feature and the page performance feature are used for training a content display model, and the content display model is used for determining target content displayed to a target user.

26. An electronic device, comprising:
a storage apparatus, having a computer program stored thereon; and
a processing apparatus configured to execute the computer program in the storage device, so as to:
acquire interaction data on a content page and loading performance data of the content page, the interaction data being used for representing a user behavior on the content page, the loading performance data being used for representing a loading condition of the content page, and the loading performance data including a loading duration and/or a loading success rate of the content page;
construct a user interaction feature according to the interaction data on the content page, and construct a page performance feature of the content page according to the loading performance data of the content page,
wherein the user interaction feature and the page performance feature are used for training a content display model, and the content display model is used for determining target content displayed to a target user.

27. The electronic device according to claim 26, wherein said acquiring the loading performance data of the content page comprises:
acquiring, as the loading performance data of the content page, at least one of: a number of times the content page is clicked, a loading success rate and a loading duration of the content page in a predetermined duration.

28. The electronic device according to claim 26, wherein said acquiring the interaction data on the content page comprises:
acquiring interaction data on each of a plurality of the content pages; and
determining average interaction data corresponding to the plurality of the content pages according to the interaction data on each of the content pages, and
said constructing the user interaction feature according to the interaction data on the content page comprises:
constructing a single interaction feature corresponding to each of the content pages according to the interaction data on each of the content pages, and constructing an average interaction feature corresponding to the plurality of the content pages according to the average interaction data corresponding to the plurality of the content pages.

29. The electronic device according to claim 26, wherein said constructing the user interaction feature according to the interaction data on the content page comprises:
sorting the interaction data on the content page according to a corresponding data index, and selecting target interaction data from the sorted interaction data; and
constructing the user interaction feature according to the target interaction data.

30. The electronic device according to claim 26, wherein said acquiring the loading performance data of the content page comprises:
acquiring the loading performance data of the content page in different time dimensions; and
said constructing the page performance feature of the content page according to the loading performance data of the content page comprises:
constructing the page performance feature of the content page according to the loading performance data of the content page in different time dimensions.

31. The electronic device according to claim 30, wherein said acquiring the loading performance data of the content page of different time dimensions comprises:
acquiring first loading performance data of the content page in a first predetermined duration and second loading performance data of the content page in a second predetermined duration, wherein time represented by the second predetermined duration is longer than time represented by the first predetermined duration; and
said constructing the page performance feature of the content page according to the loading performance data of the content page in different time dimensions comprises:
constructing the page performance feature of the content page according to the first loading performance data and the second loading performance data.

32. The electronic device according to claim 27, wherein, when the loading performance data of the content page comprises at least the number of times the content page is clicked, the loading success rate and the loading duration of the content page in the predetermined duration, the processing apparatus is configured to execute the computer program in the storage device, so as to:
determine an average number of times the content page is clicked in the predetermined duration according to the number of times the content page is clicked in the predetermined duration;
determine the loading success rate of the content page in the predetermined duration according to a number of successful loadings of the content page in the predetermined duration; and
determine an average loading duration of the content page in the predetermined duration according to the loading duration of the content page in the predetermined duration.

33. The electronic device according to claim 32, wherein said constructing the page performance feature of the content page according to the loading performance data of the content page comprises:
according to the number of times the content page is clicked, the loading success rate, the loading duration, the average number of times the content page is clicked, the loading success rate, and the average loading duration of the content page in the predetermined duration, the page performance feature of the content page comprising at least one of:
a feature of the number of times the content page is clicked in the predetermined duration;
a feature of the average number of times the content page is clicked in the predetermined duration;
a feature of the number of successful loadings of the content page in the predetermined duration;
a feature of the loading success rate of the content page in the predetermined duration;
a feature of the loading duration of the content page in the predetermined duration; and
a feature of the average loading duration of the content page in the predetermined duration.

34. The electronic device according to claim 27, wherein said acquiring the loading performance data of the content page comprises:
acquiring, as the loading performance data of the content page, at least one of: rendering time of a first element, rendering time of a largest element of an initial screen, and an accumulated rendering offset in the content page.
